(19) United States
(12) Patent Application Publication
(10) Pub. No.: US 2004/0118112 A1
(43) Pub. Date: Jun. 24, 2004

(54) Torque converter

(76) Inventor: Kozo Mori, Osaka (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/717,613

(22) Filed: Nov. 21, 2003

(30) Foreign Application Priority Data
Dec. 20, 2002 (JP) 2002-370211

(51) Int. Cl. F16D 33/00

(52) U.S. Cl. 60/330

(57) ABSTRACT

A torque converter is provided to improve the transmission efficiency of a torque converter having a low flatness ratio. An impeller 21, a turbine 22, and a stator 23 constitute a torus. The flatness ratio of the torus, which is the ratio of the axial length L to the radial length H (L/H), is less than 0.8 and the impeller 21 has at least thirty-seven impeller blades 27 on the side facing the turbine 22.

### BACKGROUND OF THE INVENTION

1. Field of the Invention

The present invention generally relates to a torque converter. More specifically, the present invention relates to a flattened torque converter.

2. BACKGROUND INFORMATION

A conventional torque converter is a device that has a torus having three bladed wheels (an impeller, a turbine, and a stator) and is configured to transmit power using a fluid disposed inside the torus. The impeller and the front cover form a fluid chamber that is filled with operating oil. The impeller chiefly has an annular impeller shell, a plurality of impeller blades fixed to the inside of the impeller shell, and an annular impeller core fixed to the inside of the impeller blades. The turbine is arranged inside the fluid chamber such that it faces opposite the impeller along the axial direction. The turbine chiefly has an annular turbine shell, a plurality of turbine blades fixed to the surface of the turbine shell that faces the impeller, and an annular turbine core fixed to the inside of the turbine blades. An inner circumferential part of the turbine shell is fixed to a flange of a turbine hub with a plurality of rivets. The turbine hub is coupled to an input shaft such that it cannot rotate relative to the input shaft. The stator is a mechanism serving to redirect the flow of the operating oil returning to the impeller from the turbine, and is arranged between an inner circumferential part of the impeller and an inner circumferential part of the turbine. The stator chiefly includes an annular stator shell, a plurality of stator blades provided on the outer circumferential surface of the stator shell, and an annular stator core fixed to the tips of the stator blades. The stator shell is supported on a stationary shaft through a one-way clutch.

Japanese Laid-open Patent Publication 2000-74174, which is hereby incorporated by reference, discloses a torque converter that is designed such that the torus has a relatively narrow or squashed shape in the axial direction, i.e., has a low flatness ratio. By flattening the torus in this manner, the overall axial length of the torque converter can be shortened, allowing the torque converter to be installed in spaces where the axial dimension is limited. Use of a flattened torque converter also enables a more powerful engine to be used and makes it easier to install transmissions having a larger number of gears. There is also the advantage of being able to install a multiple-plate lockup device or the like in the extra space obtained by using a torus with a shorter axial dimension.

It is preferred that in the torque converter the transmission of torque from the impeller to the turbine be conducted with high efficiency. Since the transmission efficiency of a torque converter tends to decline when the flatness ratio is small, there is a demand for an improvement in the transmission efficiency of torque converters having low flatness ratios.

In view of the above, it will be apparent to those skilled in the art from this disclosure that there exists a need for an improved torque converter. This invention addresses this need in the art as well as other needs, which will become apparent to those skilled in the art from this disclosure.

### SUMMARY OF THE INVENTION

An object of the present invention is to improve the transmission efficiency of torque converters having a low flatness ratio.

A torque converter in accordance with a first aspect of the present invention transmits torque using a fluid and is provided with an impeller, a turbine, and a stator. The impeller forms a fluid chamber with a front cover. The turbine is arranged in the fluid chamber so as to face the impeller. The stator is arranged between the impeller and the turbine and functions to redirect the flow of the fluid flowing from the turbine to the impeller. The impeller, turbine, and stator constitute a torus. The flatness ratio of the torus, which is the ratio of the axial length L to the radial length H (L/H), is less than 0.8. The impeller has at least 37 impeller blades on the side that faces the turbine.

While conventional torque converters generally have 29 or 31 impeller blades, the impeller of this torque converter has 37 or more impeller blades. Since the larger number of impeller blades increases the torque transmission efficiency considerably, sufficient transmission efficiency can be obtained even when the torque converter has a low flatness ratio of 0.8 or less.

A torque converter in accordance with a second aspect of the present invention is the torque converter as described in the first aspect, wherein the number of impeller blades is a prime number.

When the number of impeller blades is not a prime number, there is the possibility that the circulation of the fluid inside the fluid chamber will become periodic and cause undesirable interference. Since the number of blades in this torque converter is a prime number, the occurrence of fluid interference can be suppressed.

A torque converter in accordance with a third aspect of the present invention is the torque converter as described in the first or second aspect, wherein the flatness ratio of the torus is less than 0.7.

With this torque converter, sufficient transmission efficiency can be obtained even when the flatness ratio is less than 0.7 because the number of impeller blades has been increased relative to the prior art. Although the transmission efficiency declines due to the reduced flatness ratio, the reduced flatness ratio causes the increase in transmission ratio resulting from increasing the number of impeller blades to be larger.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a vertical cross-sectional schematic view of a torque converter in accordance with a preferred embodiment of the present invention;

FIG. 2 is a view of a graph of maximum torque transmission efficiencies of torque converters having different flatness ratios and numbers of impeller blades; and

FIG. 3 is an elevational view of an impeller of the torque converter of FIG. 1.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

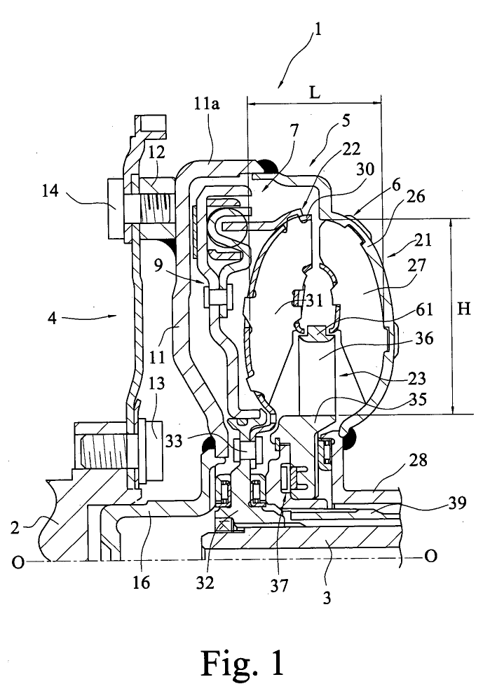

A torque converter 1 in accordance with a preferred embodiment of the present invention is shown in FIG. 1. FIG. 1 is a vertical cross-sectional schematic view of the torque converter 1. The torque converter 1 is a device that serves to transmit torque from the crankshaft 2 of an engine to the input shaft 3 of a transmission. The engine (not shown) is disposed on the left side of FIG. 1 and the transmission (not shown) is disposed on the right side of FIG. 1. Line O-O is the rotational axis of the torque converter 1.

The torque converter 1 chiefly has a flexible plate 4 and a torque converter main body 5. The flexible plate 4 is a thin, circular disc-shaped member that serves to transmit torque and also to absorb bending vibrations transmitted to the torque converter main body 5 from the crankshaft 2. The torque converter main body 5 has a torus-shaped fluid operating chamber 6 made up of three bladed wheels (an impeller 21, a turbine 22, and a stator 23) and a lockup device 7. The front cover 11 is a circular disc-shaped member arranged closely adjacent to the flexible plate 4. A center boss 16 is fixed by welding to the inner circumferential edge of the front cover 11. The center boss 16 is a cylindrical member extending in the axial direction and is inserted into a center hole of the crankshaft 2. The inner circumferential part of the flexible plate 4 is fixed with a plurality of bolts 13 to the tip surface of the crankshaft 2. A plurality of nuts 12 arranged with equal spacing in a circumferential direction are fixed to the engine side of an outer circumferential part of the front cover 11. Bolts 14 that mate with the nuts 12 fasten an outer circumferential part of the flexible plate 4 to the front cover 11.

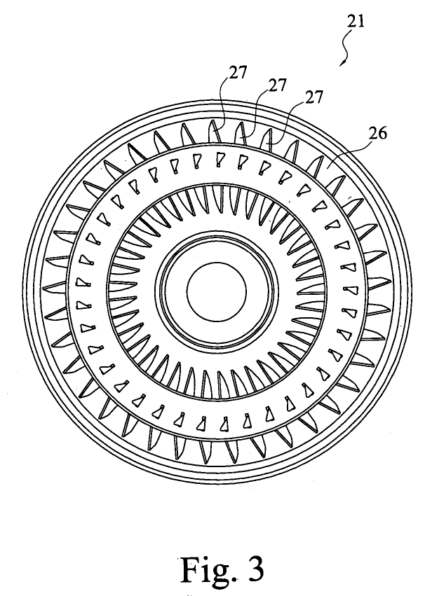

An outer cylindrical part 11a that extends axially toward the transmission is formed on the outer circumferential part of the front cover 11. The outer circumferential rim of the impeller shell 26 of the impeller 21 is welded to the tip end of the outer cylindrical part 11a. As a result, the front cover 11 and the impeller 21 form a fluid chamber that is filled with operating oil. The impeller 21 chiefly includes an impeller shell 26, impeller blades 27 fixed to the inside of the impeller shell, and an impeller hub 8 that is fixed to an inner circumferential part of the impeller shell 26. As seen in FIG. 3, the impeller preferably has thirty-seven blades in this embodiment.

Referring again to FIG. 1, the turbine 22 is arranged inside the fluid chamber in such a manner that it faces the impeller 21 in the axial direction. The turbine 22 chiefly includes a turbine shell 30, a plurality of turbine blades 31 fixed to the surface of the turbine shell that faces the impeller, and a turbine hub 32 that is fixed to the inner circumferential rim of the turbine shell 30. The turbine shell 30 and the turbine hub 32 are fastened together with a plurality of rivets 33. Splines that mate with the input shaft 3 are formed on the inner circumferential surface of the turbine hub 32. As a result, the turbine hub 32 rotates integrally with the input shaft 3.

The stator 23 is a mechanism that is arranged between an inner circumferential part of the impeller 21 and an inner circumferential part of the turbine 22. The stator 23 serves to redirect the flow of the operating oil returning to the impeller 21 from the turbine 22. The stator 23 is preferably made of a resin or aluminum alloy and fabricated as a single integral body by casting. The stator 23 chiefly has an annular stator shell 35, a plurality of stator blades 36 provided on the outer circumferential surface of the stator shell 35, and an annular stator core 61 fixed to the tip ends of the stator blades 36. The stator shell 35 is supported on a cylindrical stationary shaft 39 through a one-way clutch 37. The stationary shaft 39 extends between the outside circumferential surface of the input shaft 3 and the inside circumferential surface of the impeller hub 28.

A torus-shaped fluid operating chamber 6 is formed inside the fluid chamber by the aforementioned bladed wheels 21, 22, and 23 and shells 26, 30, and 35. Preferably, the torus-shaped fluid operating chamber 6 is defined by an axial length L and a radial height or length H. The axial length L is preferably the distance between the axial outer edges of the blades 27 and 31 at which they connect to their respective shells, 26 and 30. The radial length H is preferably the distance between the radial outer edges of the blades 27 and 31 and the part at which the stator blades 36 are fixed to the stator shell 35. Additionally, inside the fluid chamber, an annular space 9 is secured between the front cover 11 and the fluid operating chamber 6. A lockup device 7 is arranged in this annular space 9.

The flatness ratio L/H (ratio of the axial length L of the torus to the radial length H of the torus) is less than 0.8. It is also acceptable for the flatness ratio to be less than 0.7. The torque converter 1 shown in FIG. 1 has a flatness ratio of 0.68.

The one-way clutch 37 shown in the figure uses a ratchet, but it is also acceptable for the one-way clutch to have a structure that uses rollers or sprags.

Operation of the Torque Converter

When the lockup device 7 is in the released state, the transmission of torque between the front cover 11 and the turbine 22 is accomplished by the fluid drive of the operating oil between the impeller 21 and the turbine 22. The operating oil that flows from the impeller 21 to the turbine 22 rotates the turbine 22 and then returns to the impeller 21 through the stator 23.

Characteristic Features

As seen in FIGS. 1 and 3, the torque converter 1 in accordance with this embodiment of the present invention preferably has a torus with a flatness ratio of 0.68 and thirty-seven impeller blades 27.

A torque converter 1 in accordance with the present invention is provided with an impeller having at least thirty-seven impeller blades. The increased number of impeller blades 27 considerably improves the torque transmission efficiency of the torque converter 1. As a result, even if the torque converter 1 has a low flatness ratio of less than 0.8, sufficient transmission efficiency can be obtained. Since the number of impeller blades 27 is a prime number, the occurrence of undesirable interference inside the fluid operating chamber 6 can be suppressed.

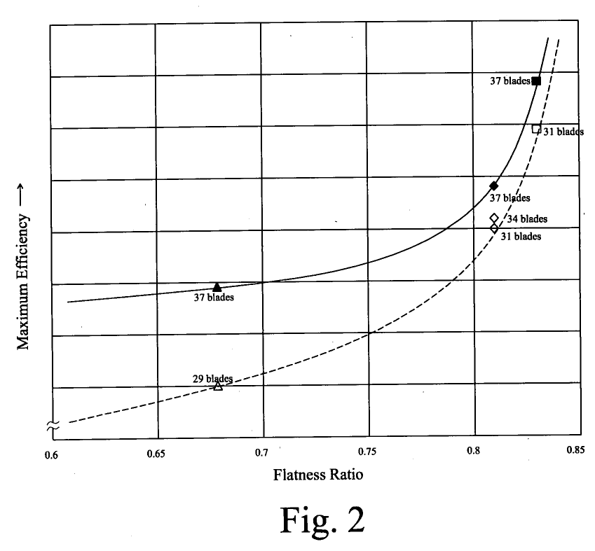

FIG. 2 shows measurement results of the change in maximum value of the transmission efficiency (maximum efficiency) with respect to the flatness ratio for conventional torque converters and for a torque converter 1 in accordance with the present invention. The values for the conventional torque converters (having twenty-nine to thirty-four impeller blades) are indicated with hollow white marks and the values for the torque converter 1 in accordance with the present invention (having thirty-seven impeller blades) are indicated with solid black marks. In FIG. 2, the broken line is a supplemental line indicating the change in maximum efficiency of a conventional torque converter when the number of impeller blades is twenty-nine and the solid line is a supplemental line indicating the change in maximum efficiency of the torque converter in accordance with the present invention, which has thirty-seven impeller blades.

The maximum efficiency of the conventional torque converters declines as the flatness ratio decreases; the transmission efficiency becomes insufficient when the flatness ratio is less than 0.8.

Conversely, in the case of the torque converter 1 in accordance with the present invention, the maximum efficiency decreases as the flatness ratio decreases but the maximum efficiency values are larger than those of the conventional torque converters because the number of impeller blades 27 is larger. As a result, the maximum efficiency values are allowable values even at flatness ratios of less than 0.8. More particularly, the measurement results of FIG. 2 indicate that the maximum efficiency values are allowable values even at flatness ratios of less than 0.7.

### EFFECTS OF THE INVENTION

The present invention can improve the transmission efficiency of torque converters having low flatness ratios.

As used herein, the following directional terms “forward, rearward, above, downward, vertical, horizontal, below, and transverse” as well as any other similar directional terms refer to those directions of a vehicle equipped with the present invention. Accordingly, these terms, as utilized to describe the present invention should be interpreted relative to a vehicle equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2002-370211. The entire disclosure of Japanese Patent Application No. 2002-370211 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A torque converter being configured to transmit torque using a fluid comprising:
a front cover;
an impeller being arranged axially opposite said front cover and forming a fluid chamber with said front cover, said impeller having at least thirty-seven impeller blades;
a turbine being arranged in said fluid chamber to face said impeller; and
a stator being arranged between said impeller and said turbine to redirect flow of the fluid flowing from said turbine to said impeller, said impeller, said turbine, and said stator constituting a torus having a flatness ratio being less than 0.8.

2. The torque converter according to claim 1, wherein the number of said impeller blades is a prime number.

3. The torque converter according to claim 2, wherein said flatness ratio of the torus is less than 0.7.

4. The torque converter according to claim 1, wherein said flatness ratio of the torus is less than 0.7.

5. A torque converter comprising:
a flexible plate being fixed to an engine crankshaft;
a front cover being non-rotatably connected to said flexible plate;
an impeller being non-rotatably connected to said front cover, and forming a fluid chamber with said front cover, said impeller having at least thirty-seven impeller blades;
a turbine being disposed axially opposite said impeller in said fluid chamber, and being configured to rotate integrally with an input shaft of a transmission; and
a stator being arranged axially between said impeller and said turbine to redirect flow of fluid returning from said turbine to said impeller,
said impeller, said turbine, and said stator constituting a torus having a flatness ratio being less than 0.8.

6. The torque converter according to claim 5, wherein the number of said impeller blades is a prime number.

7. The torque converter according to claim 6, wherein said flatness ratio of the torus is less than 0.7.

8. The torque converter according to claim 7, further comprising, a lockup device being disposed axially between said front cover and said turbine.

9. The torque converter according to claim 5, wherein said flatness ratio of the torus is less than 0.7.

10. The torque converter according to claim 9, further comprising, a lockup device being disposed axially between said front cover and said turbine.
